(19) United States
(12) Patent Application Publication
(10) Pub. No.: US 2015/0043018 A1
(43) Pub. Date: Feb. 12, 2015

(54) IMAGE FORMING DEVICE, IMAGE FORMING SYSTEM, IMAGE FORMING METHOD, AND NON-TRANSITORY COMPUTER-READABLE MEDIUM

(71) Applicant: FUJI XEROX CO., LTD., Tokyo (JP)

(72) Inventors: Shusuke TANIMOTO, Kanagawa (JP); Tomoaki HIRANO, Kanagawa (JP)

(73) Assignee: FUJI XEROX CO., LTD., Tokyo (JP)

(21) Appl. No.: 14/261,111

(22) Filed: Apr. 24, 2014

(30) Foreign Application Priority Data
Aug. 9, 2013 (JP) 2013-166222

(51) Int. Cl. G06K 15/02; H04N 1/60; G06K 15/00

(52) U.S. Cl. CPC G06K 15/1878; G06K 15/005; H04N 1/60; H04N 1/6058; H04N 2201/0094
USPC 358/1.9

(57) ABSTRACT

An image forming device includes an image data acquiring unit that acquires image data, a receiving unit that receives an instruction that includes an indication of whether or not to conduct a color change and a color change method for an image to be formed on a print medium on the basis of the image data, a display that displays an image reflecting the instruction before forming an image on a print medium, and an image forming unit that forms an image on a print medium on the basis of the image data and the instruction.

### CROSS-REFERENCE TO RELATED APPLICATIONS

This application is based on and claims priority under 35 USC 119 from Japanese Patent Application No. 2013-166222 filed Aug. 9, 2013.

### BACKGROUND

### Technical Field

The present invention relates to an image forming device, an image forming system, an image forming method, and a non-transitory computer-readable medium.

### SUMMARY

According to an aspect of the invention, there is provided an image forming device that includes an image data acquiring unit that acquires image data, a receiving unit that receives an instruction that includes an indication of whether or not to conduct a color change and a color change method for an image to be formed on a print medium on the basis of the image data, a display that displays an image reflecting the instruction before forming an image on a print medium, and an image forming unit that forms an image on a print medium on the basis of the image data and the instruction.

### BRIEF DESCRIPTION OF THE DRAWINGS

Exemplary embodiments of the present invention will be described in detail based on the following figures, wherein:

FIG. 1 illustrates an exemplary overall configuration of an image forming system applying an exemplary embodiment;

FIG. 2 is a diagram illustrating a hardware configuration of a client device;

FIG. 3 is a diagram illustrating an exemplary hardware configuration of an image forming device;

FIG. 4 is a diagram illustrating an exemplary functional configuration of an image forming system according to an exemplary embodiment;

FIGS. 5A to 5D are diagrams explaining a color universal print process as a first example of a target of a prohibition process;

FIGS. 6A and 6B are diagrams explaining a process of printing a code image as a second example of a target of a prohibition process;

FIG. 7 is a flowchart illustrating exemplary operations of a client device;

FIG. 8 is a flowchart illustrating exemplary operations of an image forming device;

FIGS. 9A to 9E illustrate screens displayed on a display when full color print instructions are given and a color universal process is not set on a client device;

FIGS. 10A and 10B illustrate screens displayed on a display when full color print instructions are given and a color universal process is set on a client device;

FIGS. 11A and 11B illustrate screens displayed on a display when two-color print instructions are given and a color universal process is not set on a client device; and

FIGS. 12A and 12B illustrate screens displayed on a display when black and white print instructions are given on a client device.

### DETAILED DESCRIPTION

### First Exemplary Embodiment

First, a first exemplary embodiment will be described.

<Description of Overall Configuration of Image Forming System>

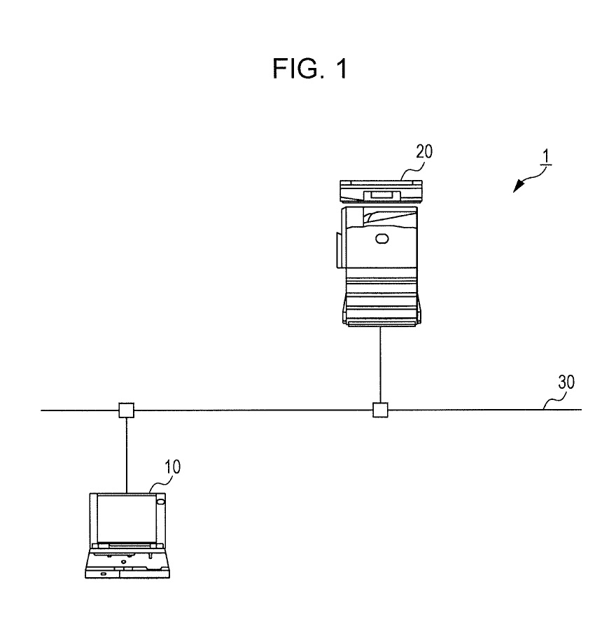

FIG. 1 illustrates an exemplary overall configuration of an image forming system applying an exemplary embodiment.

The image forming system 1 illustrated herein is one embodiment of an image forming system according to an exemplary embodiment. Furthermore, the image forming system 1 includes a client device 10 as an example of an image data creator that creates image data for forming an image onto a print medium (paper sheet), an image forming device 20 as an example of image forming equipment forms an image onto the print medium on the basis of image data created by the client device 10, and a network 30 connected to the client device 10 and the image forming device 20. Note that although FIG. 1 only illustrates one each of the client device 10 and the image forming device 20, two or more client devices 10 and image forming devices 20 may also be provided.

The client device 10 is a computer device that requests image printing from the image forming device 20. Herein, the client device 10 may be exemplified as a personal computer (PC).

The image forming device 20 is a device that forms an image on a print medium and outputs the result as a print medium. Herein, the device used as the image forming device 20 may be a device provided with such printer functions only, or an device provided with other image processing functions, such as scanner functions and facsimile functions in addition to printer functions.

The network 30 is a communication medium used for information communication between the client device 10 and the image forming device 20, and may be a local area network (LAN) or a wide area network (WAN), for example.

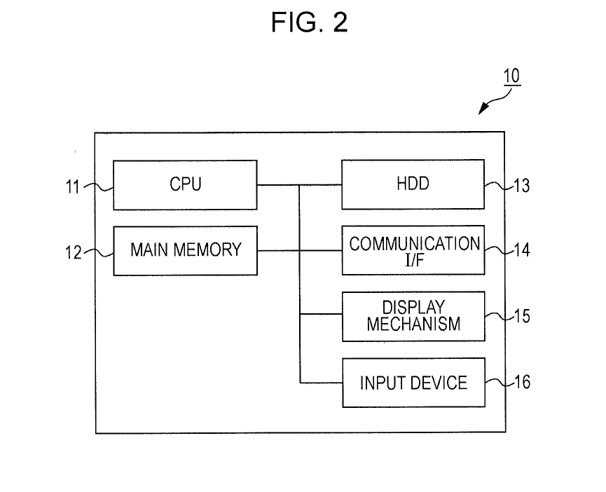

FIG. 2 is a diagram illustrating a hardware configuration of a client device 10.

As illustrated in FIG. 2, the client device 10 is equipped with a central processing unit (CPU) 11 as a computational component, as well as main memory 12 and a hard disk drive (HDD) 13 as storage components. Herein, the CPU 11 executes various software, such as an operating system (OS) and applications. Also, the main memory 12 is a storage area that stores information such as various software and data used in the execution thereof, while the HDD 13 is a storage area that stores information such as input data that is input into various software and output data that is output from various software.

Furthermore, the client device 10 is equipped with a communication interface (hereinafter designated “communication I/F”) 14 for communicating externally, a display mechanism 15 that displays images and is made up of video memory and a display or the like, and an input device 16 such as a keyboard and mouse.

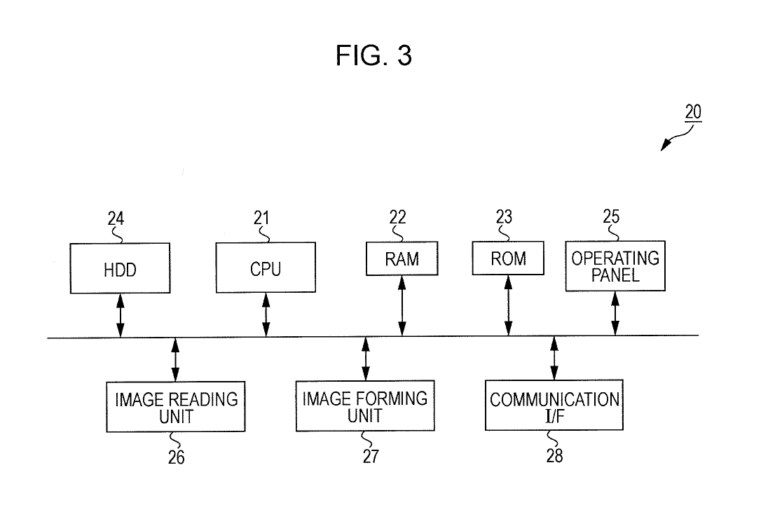

FIG. 3 is a diagram illustrating an exemplary hardware configuration of an image forming device 20.

As illustrated in FIG. 3, the image forming device 20 is provided with a CPU 21, random access memory (RAM) 22, read-only memory (ROM) 23, an HDD 24, an operating panel 25, an image reading unit 26, an image forming unit 27, and a communication interface (hereinafter designated the “communication I/F”) 28.

The CPU 21 realizes the respective functions described below by loading various programs stored in the ROM 23 or elsewhere into the RAM 22 and executing the programs.

The RAM 22 is memory used as work memory for the CPU 21, for example.

The ROM 23 is memory that stores information such as the various programs executed by the CPU 21.

The HDD 24 is, for example, a magnetic disk device that stores information such as image data that has been read by the image reading unit 26 and image data used for image formation in the image forming unit 27.

The operating panel 25 is, for example, a touch panel that displays various information and accepts operating input from a user.

The image reading unit 26 reads an image printed onto a print medium such as paper. Herein, the image reading unit 26 is a scanner, for example, and may be a charge-coupled device (CCD) scanner in which light from a light source is radiated onto a document and the reflected light therefrom is focused by a lens and sensed by a CCD, or a contact image sensor (CIS) scanner in which light from LED light sources is successively radiated onto a document and the reflected light therefrom is sensed by a CIS.

The image forming unit 27 forms an image onto a print medium. Herein, the image forming unit 27 is a printer, for example, and may be an electrophotographic system in which an image is formed by causing toner adhering to a photoconductor to be transferred to a print medium, or an inkjet printer in which an image is formed by ejecting ink onto a print medium.

The communication I/F 28 transmits and receives various information to and from other devices via the network 30.

Next, general operations of the image forming system 1 will be described.

An image forming system 1 according to the present exemplary embodiment is what is called a accumulation print system. When a user transmits print instructions from the client device 10, the image data is temporarily stored in the image forming device 20. After that, when a user gives instructions to print on the image forming device 20, printing onto a print medium is conducted. A more specific description is given below.

(1) First, a user operates the client device 10, and displays an image desired for printing by the image forming device 20 on the display mechanism 15 of the client device 10.

(2) The user then recognizes the image displayed on the display mechanism 15, and gives instructions from the client device 10 to print the image by the image forming device 20.

(3) As a result, image data for conducting printing is created on the client device 10, and this image data is transmitted to the image forming device 20 via the communication I/F 14 and the network 30.

(4) The image forming device 20 receives the transmitted image data via the communication I/F 28, and temporarily stores the image data in the HDD 24.

(5) Meanwhile, the user operates the operating panel 25 of the image forming device 20, and inputs information such as a user ID and password. The user then selects a desired image to print from a displayed menu or the like, and gives print instructions.

(6) As a result, the image forming unit 27 conducts printing, and a print medium is output.

Herein, in the above (5), the user may want to change the colors of the image to be printed in some cases. In other words, in the image forming system 1 according to the present exemplary embodiment, the user goes to the location where the image forming device 20 is installed, and gives instructions on whether or not to actually print at the image forming device 20. At this point, although the user may have transmitted instructions to print in full color from the client device 10, for example, in some cases the user may want to reduce the number of colors or print in black and white in order to reduce printing costs.

Accordingly, the present exemplary embodiment addresses the above situation with a functional configuration of the image forming device 20 like the following.

<Description of Functional Configuration of Image Forming System>

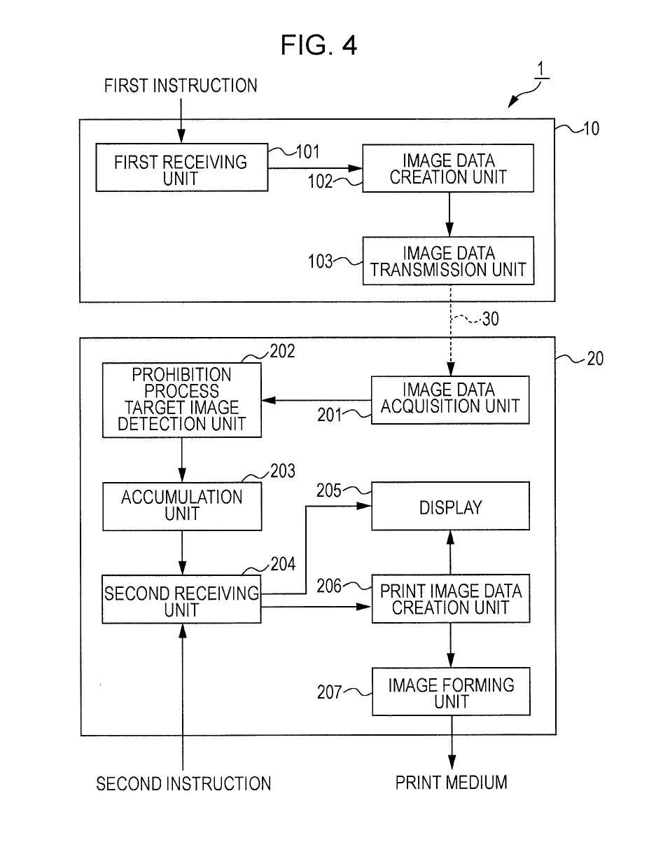

FIG. 4 illustrates an exemplary functional configuration of an image forming system 1 according to the present exemplary embodiment.

As discussed above, an image forming system 1 according to the present exemplary embodiment is equipped with a client device 10 as an example of an image data creator, an image forming device 20 as an example of image forming equipment, and a network 30 as an example of a communication medium between the client device 10 and the image forming device 20.

The client device 10 is equipped with a first receiving unit 101, an image data creation unit 102, and an image data transmission unit 103.

The first receiving unit 101 receives a first instruction that includes an indication of whether or not to conduct a color change as well as a color change method for an image to be formed by the image forming device 20. In the present exemplary embodiment, the first receiving unit 101 receives an instruction to print without conducting a color change as the first instruction. The first print instruction may also include a control command that signifies a print start command, and information on print parameters such as the number of copies to print, whether to conduct one-sided or two-sided printing, an enlarge/reduce factor, and whether an image corresponds to the target of a prohibition process discussed later (a prohibition process target image).

The image data creation unit 102 creates image data that includes image information for conducting printing and first instruction information. In other words, the image data creation unit 102 acquires image information for conducting printing that has been created by software such as an application running on the client device 10. The image data creation unit 102 then adds the above first instruction information to this image information to create image data. Specifically, the first instruction information is embedded as a header or the like in the image data.

The image data transmission unit 103 transmits image data to the image forming device 20. In the case of the present exemplary embodiment, the image data transmission unit 103 transmits image data that includes full color image information.

If the above functional configuration of the client device 10 is described in association with the hardware configuration of the client device 10 in FIG. 2, image information is created as a result of the CPU 11 loading software such as an application stored in the HDD 13 into the main memory 12 and executing the software, while the user uses the display mechanism 15 and operates the input device 16. Also, the first instruction is input as a result of the user operating the input device 16 on a print settings window displayed on the display mechanism 15 by software similarly executed by the CPU 11.

In addition, the respective functions of the first receiving unit 101 and the image data creation unit 102 may be realized by software executed by the CPU 11. Furthermore, the image data transmission unit 103 may be realized as a function of the communication I/F 14.

Meanwhile, the image forming device 20 is equipped with an image data acquisition unit 201, a prohibition process target image detection unit 202, an accumulation unit 203, a second receiving unit (receiving unit) 204, a display 205, a print image data creation unit 206, and an image forming unit 207.

The image data acquisition unit 201 acquires image data transmitted from the image data transmission unit 103 via the network 30.

When a color change is conducted for an image created on the basis of image data acquired by the image data acquisition unit 201, the prohibition process target image detection unit 202 detects whether or not the image data includes a prohibition process target image that would produce an inexpedience in the image to be formed. This prohibition process target image will be discussed later.

The accumulation unit 203 temporarily accumulates image data. In other words, the accumulation unit 203 is a functional unit responsible for the accumulation function in the accumulation print system discussed earlier.

The second receiving unit 204 receives a second instruction (instruction) that includes an indication of whether or not to conduct a color change as well as a color change method for an image that reflects the first instruction. At this point, on the basis of the image data, a color change instruction is received for an image to be formed within the range of information included in the image data. Specifically, by inputting a second instruction into the second receiving unit 204, the user is able to change which colors and the number of colors used in order to form an image by the image forming unit 207. For example, the number of colors used to form an image by the image forming unit 207 may be reduced (color reduction), or changed to print in black in white. Also, by inputting a second instruction into the second receiving unit 204, the user may change the chromatic colors. For example, an image made up of a combination of black and a chromatic color may be changed to an image made up of black and another chromatic color, such as changing an image made up of a combination of black and red to black and blue. Note that in the second receiving unit 204, information such as a user ID and password for authenticating the user is also received.

The display 205 displays an image reflecting the first instruction and the second instruction before forming the image. In other words, the display 205 presents to the user a preview screen of the image to be formed. Herein, a preview screen is displayed before forming an image within the range of information included in the image data acquired by the image data acquisition unit 201. With a screen displayed by the display 205, the user is able to ascertain the state of the image to be formed before printing. Subsequently, upon judging that the image displayed on the display 205 is to be printed in the current state, the user gives a print instruction to the second receiving unit 204 as an example of the second instruction. On the other hand, if the user perceives an inexpedience in the image displayed on the display 205, the user inputs an instruction to conduct an additional color change into the second receiving unit 204 as the second instruction. The instruction to conduct a color change may be an instruction for a different color change than the color change instruction that was input previously, or an instruction to cancel the color change instruction.

The print image data creation unit 206, on the basis of the image data acquired by the image data acquisition unit 201 and the second instruction, creates print image data, which is data for actually conducting printing. In other words, when the user inputs a print instruction into the second receiving unit 204 as an example of the second instruction, the print image data creation unit 206 creates print image data in accordance with the color change instruction from the user. Note that the print image data may also be used as information for the preview screen displayed on the display 205.

The image forming unit 207 forms an image onto a print medium using print image data. Subsequently, the print medium with an image formed thereon is delivered outside the image forming device 20.

If the above functional configuration of the image forming device 20 is described in association with hardware configuration of the image forming device 20 in FIG. 3, the image data acquisition unit 201 may be realized by the communication I/F 28, and the accumulation unit 203 by the HDD 24. Additionally, the second receiving unit 204 and the display 205 may be realized by the operating panel 25. In other words, the user follows a menu displayed on the display 205 and inputs a second instruction such as a color change method by performing an operation such as touching a touch panel. Also, the function of creating print image data by the print image data creation unit 206 is realized as a result of the CPU 21 loading a program stored in the ROM 23 or the like into the RAM 22 and executing the program, and the program conducting image processing on the image data. Subsequently, an image of a preview screen is additionally created on the basis of the print image data, and displayed on the operating panel 25. Also, the function of the prohibition process target image detection unit 202 is similarly realized as a result of the CPU 21 executing a program that analyzes image data and detects a prohibition process target image. Also, the function of the image forming unit 207 may be conducted by the image forming unit 27.

<Description of Prohibition Process Target Image>

Herein, a prohibition process refers to a process that avoids producing an inexpedience in the image to be formed when a color change is conducted on the image to be formed as discussed above. Hereinafter, this prohibition process will be described.

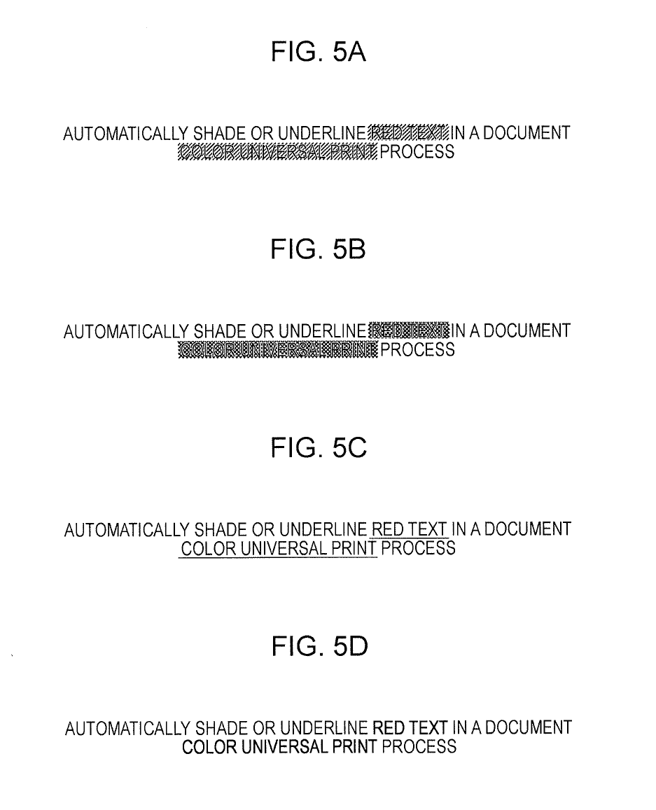

FIGS. 5A to 5D are diagrams explaining a color universal print process as a first example of a target of a prohibition process.

This color universal print process is a process that changes an image to be formed for colorblind persons.

Described specifically, first, the image in FIG. 5D is the original image. This image is made up of a text image that states, “Automatically shade or underline red text in a document/Color universal print process”. Additionally, assume that in this text image, the “red text” and “Color universal print” portions are red.

In addition, a process that changes this image to the images in FIGS. 5A to 5C, for example, is conducted for colorblind persons who have difficulty seeing red.

First, FIG. 5A illustrates a process that applies red shading to the red portions “red text” and “Color universal print”. Consequently, even a colorblind person who has difficulty seeing red is able to determine that the shaded portions are red.

Also, FIG. 5B illustrates a process that sets the red portions “red text” and “Color universal print” to black, and additionally applies shading. Consequently, it is possible to determine that the shaded portions were originally red.

Additionally, FIG. 5C illustrates a process that sets the red portions “red text” and “Color universal print” to black, and additionally adds underlining. Consequently, it is possible to determine that the underlined portions were originally red.

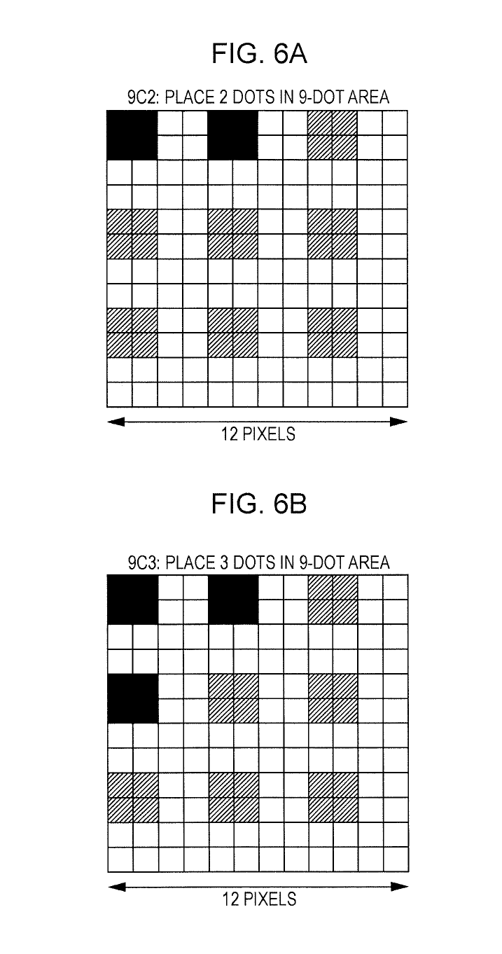

FIGS. 6A and 6B are diagrams explaining a process of printing a code image as a second example of a target of a prohibition process.

This example illustrates a case of forming a code image as an image expressing predetermined information with a dot arrangement.

In FIGS. 6A and 6B, the black areas and the shaded areas represent dot placement areas, while the white areas in between represent dot non-placement areas. Additionally, among the dot placement areas, the black areas indicate areas in which a dot is placed, whereas the shaded areas indicate areas in which a dot is not placed. In other words, FIGS. 6A and 6B illustrate an example of providing dot placement areas for three dots vertically and three dots horizontally, for a total of nine dots. Among these, FIG. 6A is a unit code pattern in a 9C2 scheme that places two dots in the dot placement areas, while FIG. 6B is a code image in a 9C3 scheme that places three dots in the dot placement areas. In the present exemplary embodiment, mCn potential patterns of information (where mCn=m!/{(m−n)!xn!}) are expressed by pattern images (hereinafter designated “unit code patterns”) formed by placing a unit image in n places (where 1≦n<m) selected from m places (where m≧3). In addition, with an arrangement of such unit code patterns, it is possible to express coordinate information or document identification information printed onto a print medium.

Note that a process that forms an image expressing predetermined information with a dot arrangement in this way may also include other cases, such as the case of forming a watermark on a print medium or the like.

Additionally, in the present exemplary embodiment, when the prohibition process target image detection unit 202 (see FIG. 4) detects that a prohibition process target image is included in the image data, the second receiving unit 204 (see FIG. 4) restricts color change (that is, conducts a prohibition process) on the basis of the detection by the prohibition process target image detection unit 202. In other words, in the case of conducting a color change, and particularly when conducting color reduction, the advantages described in FIGS. 5A to 5D and FIGS. 6A and 6B may no longer be exhibited. For this reason, in the case in which a prohibition process target image is included in the image data, color change is restricted (that is, a prohibition process is conducted).

To describe this restriction specifically, a prohibition on all color change is conceivable, for example. It is also conceivable to narrow the range over which color change may be conducted so that effects such as color universal printing and code image printing as discussed above are not impaired. Furthermore, it may be configured such that, if the prohibition process target image detection unit 202 detects a prohibition process target image, a warning display is presented to the user on the display 205 (see FIG. 4).

### Second Exemplary Embodiment

Next, a second exemplary embodiment will be described. The second exemplary embodiment describes the case in which the first receiving unit 101 receives an instruction to conduct a color change and print as the first instruction.

The functional configuration of an image forming system 1 according to the present exemplary embodiment is similar to FIG. 4. In other words, an image forming system 1 according to the present exemplary embodiment is equipped with a client device 10, an image forming device 20, and a network 30. Additionally, the client device 10 is equipped with a first receiving unit 101, an image data creation unit 102, and an image data transmission unit 103, while the image forming device 20 is equipped with an image data acquisition unit 201, a prohibition process target image detection unit 202, an accumulation unit 203, a second receiving unit (receiving unit) 204, a display 205, a print image data creation unit 206, and an image forming unit 207.

However, the present exemplary embodiment differs from the first exemplary embodiment in that the first receiving unit 101 of the client device 10 receives an instruction to conduct a color change and print as the first instruction.

At this point, the image data creation unit 102 creates image data that includes image information and first instruction information for conducting printing, but creates the image data using image information that does not reflect a color change instruction. In other words, even if there is an instruction for color reduction or the like as the first instruction, image data is created on the basis of full color image information that is not subjected to a color reduction or the like. The image data transmission unit 103 then transmits image data including full color image information to the image forming device 20.

According to such a configuration, when the second receiving unit 204 of the image forming device 20 receives a second instruction, it becomes possible to receive an instruction to increase the number of colors in the image to be formed (color increase) as a color change. In other words, when the image data creation unit 102 discussed above creates image data, if image data is created using image information that reflects a color change instruction, such as in the case of receiving a color reduction instruction as the first instruction, for example, the color-reduced image information will be used. Subsequently, since the image forming device 20 is unable to increase colors on the basis of the color-reduced image information, when the second receiving unit 204 receives a second instruction, a color increase instruction may not be accepted as a color change. Conversely, when the image data creation unit 102 creates image data, if image data is created using image information that does not reflect a color change instruction, the image forming device 20 is able to acquire full color image information before color reduction, and when the second receiving unit 204 receives a second instruction, it becomes possible to receive a color increase instruction as the color change.

<Description of Client Device Operations>

Next, operations of the client device 10 will be described. Note that the following description of operations of the client device 10 includes both the first exemplary embodiment and the second exemplary embodiment discussed above.

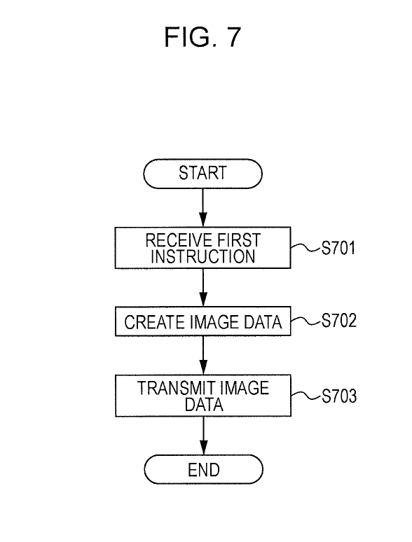

FIG. 7 is a flowchart illustrating exemplary operations of the client device 10.

Hereinafter, FIGS. 4 and 7 will be used to describe operations of the client device 10.

First, the first receiving unit 101 receives a first instruction that includes a control command signifying a print start command and print parameters such as a color change (step 701).

Next, the image data creation unit 102 creates image data that includes image information and first instruction information for conducting printing (step 702).

Subsequently, the image data transmission unit 103 transmits image data to the image forming device 20 (step 703).

<Description of Image Forming Device Operations>

Next, operations of the image forming device 20 will be described. Note that the following description of operations of the image forming device 20 includes both the first exemplary embodiment and the second exemplary embodiment discussed above.

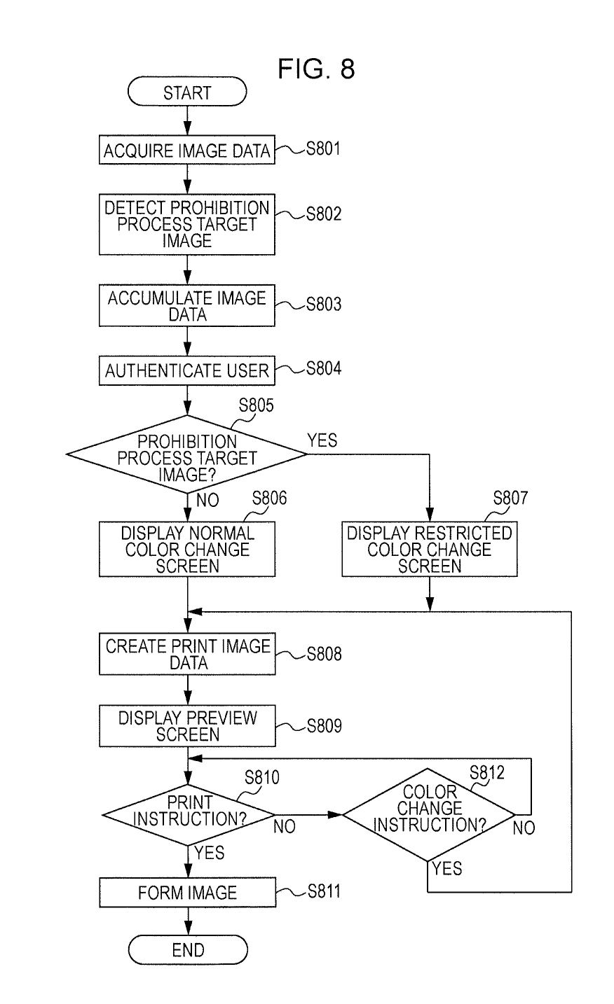

FIG. 8 is a flowchart illustrating exemplary operations of the image forming device 20.

Hereinafter, FIGS. 4 and 8 will be used to describe operations of the image forming device 20.

First, the image data acquisition unit 201 acquires image data transmitted from the image data transmission unit 103 via the network 30 (step 801).

Next, the prohibition process target image detection unit 202 detects a prohibition process target image included in the image data (step 802).

Next, the accumulation unit 203 temporarily accumulates image data (step 803). At this point, the accumulation unit 203 also accumulates information related to a prohibition process target image, such as the type of prohibition process target image detected by the prohibition process target image detection unit 202, and the location in the image data.

The second receiving unit 204 then receives a user ID and password, and authenticates a user (step 804).

After user authentication, the second receiving unit 204 determines whether or not the prohibition process target image detection unit 202 has detected that a prohibition process target image is included in the image data (step 805). Subsequently, in the case in which a prohibition process target image is not included in the image data (step 805, No), a screen for receiving a normal color change is displayed on the display 205 (step 806).

On the other hand, in the case in which a prohibition process target image is included in the image data (step 805, Yes), a screen with color change-related restrictions imposed on the basis of the content of the prohibition process target image is displayed on the display 205 (step 807). Also, color change may be made unavailable at this point.

In addition, the print image data creation unit 206 creates print image data (step 808). The display 205 then displays a screen for receiving a color change together with a preview screen created from this print image data (step 809).

Next, the second receiving unit 204 judges whether or not a print instruction was output from the user (step 810). Subsequently, in the case in which a print instruction was output from the user (step 810, Yes), the image forming unit 207 forms an image on a print medium with the print image data (step 811).

On the other hand, in the case in which a print instruction has not been output from the user (step 810, No), the second receiving unit 204 judges whether or not a color change was output from the user (step 812).

Subsequently, in the case in which a color change instruction was output from the user (step 812, Yes), the process returns to step 808. In other words, in step 808, the print image data creation unit 206 creates color-changed print image data, and in step 809, the display 205 displays a screen for receiving a color change together with a color-changed preview screen.

On the other hand, in the case in which a color change instruction has not been output from the user (step 812, No), the process returns to step 810.

<Description of Screens Displayed on Display>

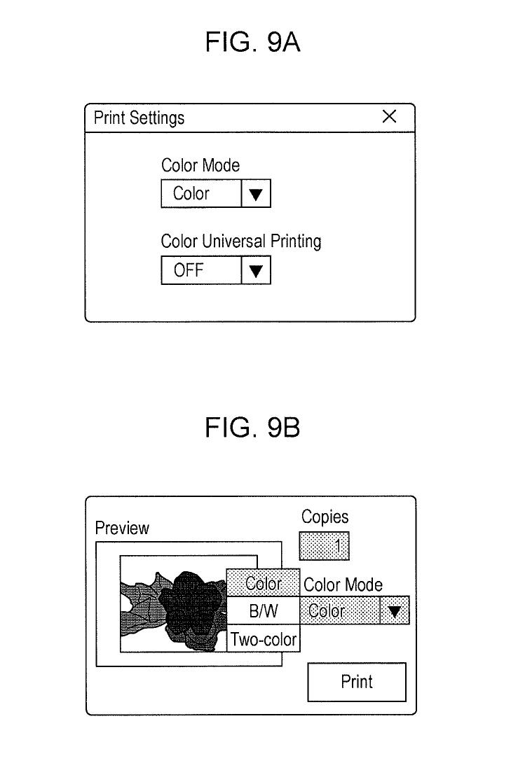

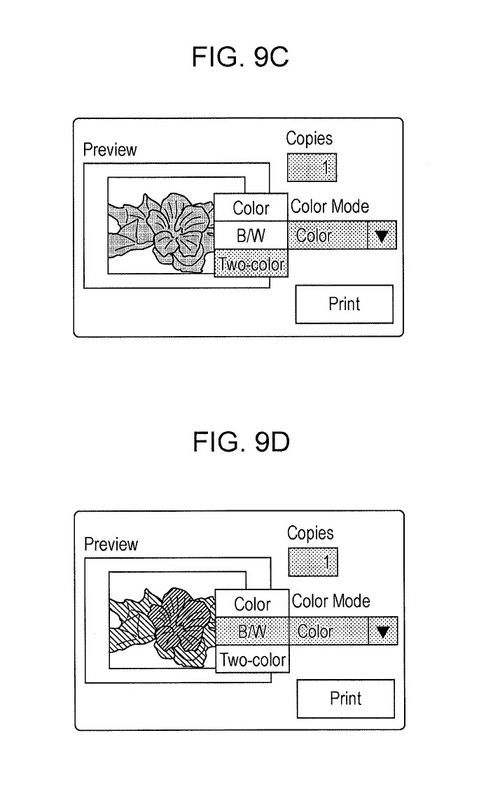

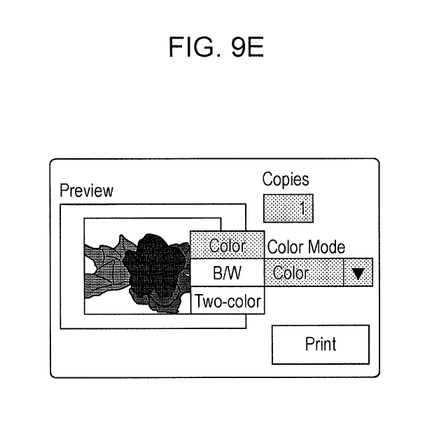

FIGS. 9A to 12B are diagrams illustrating examples of screens displayed on the display 205 of the image forming device 20.

Of these, the examples in FIGS. 9A to 9E illustrate screens displayed on the display 205 when full color print instructions are given and a color universal process is not set on the client device 10.

First, FIG. 9A illustrates a print settings window displayed on the display mechanism 15 of the client device 10. Herein, the user selects “Color” as the color mode, and also sets color universal printing to “OFF”, for example. In other words, at this point, the user gives, as the above first instruction, an instruction to print in full color and also to not conduct color universal printing.

Additionally, FIG. 9B is a screen displayed on the display 205 at this point. This corresponds to the screen displayed in step 806 and step 809 in the example of FIG. 8.

The screen displayed on the display 205 at this point is a screen for receiving a normal color change, and enables the selection of any of “Color”, “B/W”, and “Two-color” as the color mode. By default, “Color” is selected. Additionally, a full color preview screen corresponding to the “Color” color mode is displayed on the same screen.

Subsequently, as illustrated in FIG. 9C, if the user changes the color mode to “Two-color” as the above second instruction, there is displayed a preview screen corresponding to the “Two-color” color mode, using black and red, for example.

Also, as illustrated in FIG. 9D, if the user additionally changes the color mode to “B/W” as the above second instruction, a black and white preview screen corresponding to the “B/W” color mode is displayed.

Note that, as illustrated in FIG. 9E, if the user additionally reverts the color mode back to “Color” as the above second instruction, the preview screen returns to a full color preview screen corresponding to the “Color” color mode.

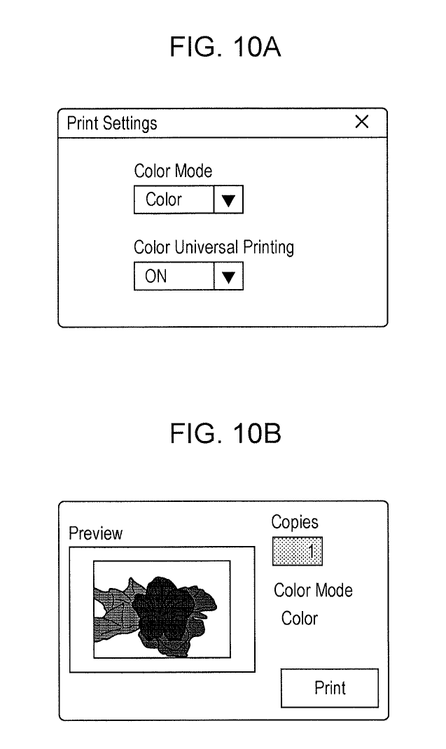

Next, the examples in FIGS. 10A and 10B illustrate screens displayed on the display 205 when full color print instructions are given and color universal printing is set on the client device 10.

First, as illustrated in FIG. 10A, the user selects “Color” as the color mode, and also sets color universal printing to “ON” on the client device 10. In other words, at this point, the user gives, as the above first instruction, an instruction to print in full color and also to conduct color universal printing.

Additionally, FIG. 10B is a screen displayed on the display 205 at this point. This corresponds to the screen displayed in step 807 and step 809 in the example of FIG. 8.

The screen displayed on the display 205 at this point is a screen for receiving a restricted color change, and only “Color” is available for selection as the color mode. Note that a full color screen corresponding to the “Color” color mode is displayed as the preview screen.

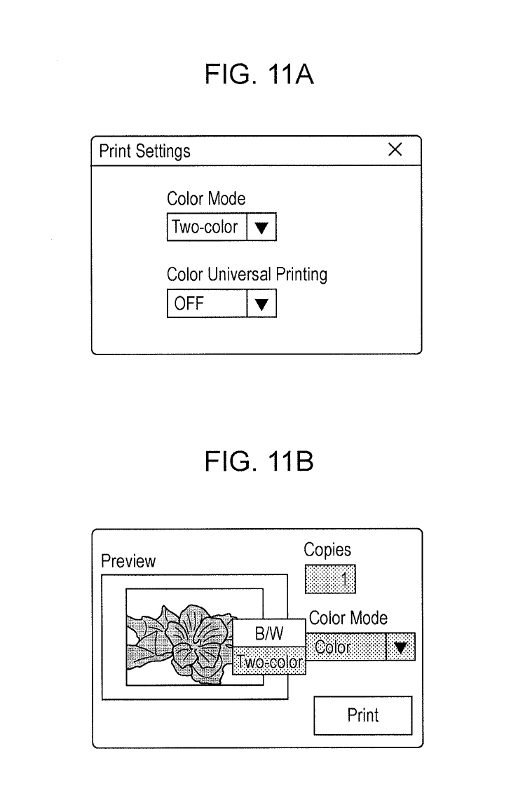

In addition, the examples in FIGS. 11A and 11B illustrate screens displayed on the display 205 when two-color print instructions are given and color universal printing is not set on the client device 10.

First, as illustrated in FIG. 11A, the user selects “Two-color” as the color mode, and also sets color universal printing to “OFF” on the client device 10. In other words, at this point, the user gives, as the above first instruction, an instruction to print in two colors and also to not conduct color universal printing.

Additionally, FIG. 11B is a screen displayed on the display 205 at this point. This corresponds to the screen displayed in step 806 and step 809 in the example of FIG. 8.

The screen displayed on the display 205 at this point is a screen for receiving a normal color change, and enables the selection of any of “B/W” and “Two-color” as the color mode. By default, “Two-color” is selected. Note that this screen illustrates the case of not conducting a color increase process. Additionally, a preview screen corresponding to the “Two-color” color mode, using black and red, for example, is displayed on the same screen. Note that in FIG. 11B, in the case of conducting a color increase process, a screen similar to FIG. 9C is displayed, and any of “Color”, “B/W”, and “Two-color” may be selected as the color mode.

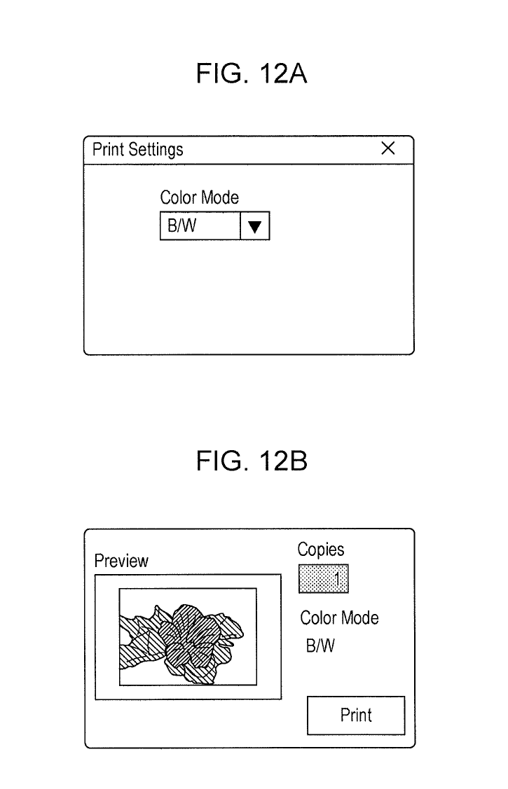

In addition, the examples in FIGS. 12A and 12B illustrate screens displayed on the display 205 when black and white print instructions are given on the client device 10.

First, as illustrated in FIG. 12A, the user selects “B/W” as the color mode. Note that in this case, the setting for color universal printing is made unavailable. In other words, at this point, since the user has given an instruction to print in black and white as the above first instruction, color universal printing is not available.

Additionally, FIG. 12B is a screen displayed on the display 205 at this point. This corresponds to the screen displayed in step 806 and step 809 in the example of FIG. 8.

The screen displayed on the display 205 at this point is a screen for receiving a normal color change, but only “B/W” is available for selection as the color mode. Note that this screen illustrates the case of not conducting a color increase process. Additionally, a black and white preview screen corresponding to the “B/W” color mode is displayed on the same screen. Note that in FIG. 12B, in the case of conducting a color increase process, a screen similar to FIG. 9D is displayed, and any of “Color”, “B/W”, and “Two-color” may be selected as the color mode.

According to the first exemplary embodiment and the second exemplary embodiment described above, the results of a color change applied to accumulated image data are reflected in a preview screen on the display 205, are and thus easily recognizable by a user. For this reason, convenience is improved for the user.

Also, according to the first exemplary embodiment and the second exemplary embodiment, a prohibition process target image in image data is detected by a prohibition process target image detection unit 202, color change is restricted so as to minimize degradation of the desired print effects, and a preview screen within the boundaries of the restriction is displayed on the display 205.

Note that although the image forming device 20 is provided with an accumulation unit 203 and accumulates image data in the examples described above, a configuration is not strictly limited thereto. For example, a print server which is connected to the network 30 and which manages printing on the image forming device 20 may be separately provided, and image data may be accumulated on this print server.

Furthermore, a cloud print service may be used, and image data may be accumulated on a server computer that provides the cloud print service.

<Description of Program>

In addition, as discussed earlier, a process conducted by an image forming device 20 according to an exemplary embodiment is conducted by a program that realizes various functions of the image forming device 20, for example.

Consequently, a process conducted by the image forming device 20 may also be interpreted as being a process that causes a computer to realize an image data acquisition function that acquires image data, a receiving function that receives an instruction including whether or not to conduct a color change and a color change method for an image to be formed on a print medium on the basis of the image data, and a display function that displays an image reflecting the instruction before forming an image on a print medium.

Also, the program may additionally include a prohibition process target image detection function that detects whether or not the image data includes a prohibition process target image that causes an inexpedience in the image to be formed when a color change is conducted for the image to be formed on the basis of the acquired image data. The receiving function conducts a process of restricting color change if the prohibition process target image detection function detects that the image data includes a prohibition process target image.

Note that a program realizing an exemplary embodiment obviously may be provided via a communication medium, and may also be provided by being stored on a recording medium such as CD-ROM.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming device comprising:
an image data acquiring unit that acquires image data;
a receiving unit that receives an instruction that includes an indication of whether or not to conduct a color change and a color change method for an image to be formed on a print medium on the basis of the image data;
a display unit that displays an image reflecting the instruction before forming an image on the print medium; and
an image forming unit that forms an image on the print medium on the basis of the image data and the instruction.

2. The image forming device according to claim 1, wherein
the color change received by the receiving unit reduces the number of colors used to form an image by the image forming unit.

3. The image forming device according to claim 1, further comprising:
a prohibition process target image detection unit that detects whether or not the image data includes a prohibition process target image that would produce an inexpedience in an image to be formed when conducting a color change on the image to be formed on the basis of the image data;
wherein the receiving unit restricts color change if the prohibition process target image detection unit detects that the image data includes a prohibition process target image.

4. The image forming device according to claim 2, further comprising:
a prohibition process target image detection unit that detects whether or not the image data includes a prohibition process target image that would produce an inexpedience in an image to be formed when conducting a color change on the image to be formed on the basis of the image data;
wherein the receiving unit restricts color change if the prohibition process target image detection unit detects that the image data includes a prohibition process target image.

5. The image forming device according to claim 3, wherein
the prohibition process target image is an image formed for colorblind persons.

6. The image forming device according to claim 3, wherein
the prohibition process target image is an image expressing predetermined information with a dot arrangement.

7. An image forming system comprising:
an image data creation unit that creates image data; and
an image forming unit that forms an image on a print medium on the basis of the image data;
wherein the image forming unit includes
an image data acquiring unit that acquires the image data,
a receiving unit that receives an instruction that includes an indication of whether or not to conduct a color change and a color change method for an image to be formed on the print medium on the basis of the image data,
a display unit that displays an image reflecting the instruction before forming an image on a print medium, and
an image forming unit that forms an image on the print medium on the basis of the image data and the instruction.

8. A non-transitory computer readable medium storing a program causing a computer to execute a process for forming an image, the process comprising:
acquiring image data;
receiving an instruction that includes an indication of whether or not to conduct a color change and a color change method for an image to be formed on a print medium on the basis of the image data; and
displaying an image reflecting the instruction before forming an image on the print medium; and

9. The non-transitory computer readable medium according to claim 8, the process further comprising:
detecting whether or not the image data includes a prohibition process target image that would produce an inexpedience in an image to be formed when conducting a color change on the image to be formed on the basis of the image data;
wherein the receiving restricts color change if the prohibition process target image detecting detects that the image data includes a prohibition process target image.
